(19) United States
(12) Patent Application Publication
(10) Pub. No.: US 2021/0051110 A1
(43) Pub. Date: Feb. 18, 2021

(54) Communication Node and Method for Handling Communications between Nodes of a System

(71) Applicant: Telefonaktiebolaget LM Ericsson (publ), Stockholm (SE)

(72) Inventors: Dániel Géhberger, Budapest (HU); Péter Mátray, Budapest (HU); Gabor Nemeth, Budapest (HU)

(21) Appl. No.: 16/610,663

(22) PCT Filed: May 10, 2017
(86) PCT No.: PCT/EP2017/061231

§ 371 Date: Nov. 4, 2019

(51) Int. Cl. H04L 12/823; H04L 12/841; H04W 52/02

(52) U.S. Cl. CPC H04L 47/32; H04W 52/0258; H04L 47/28

(57) ABSTRACT

There is provided a communication node of a system and a method for handling communications between nodes of the system. Information indicative of at least one condition in the system is acquired (300). For each request transmitted by a node of the system and targeted for another node of the system, a mode in which to wait for reception of a response to the request from the targeted node is selected based on the acquired information (302).

### TECHNICAL FIELD

The present idea relates to a communication node and method for handling communications between nodes of a system.

### BACKGROUND

In any communication system, it is desirable to achieve low latency and energy efficiency such that high throughput is possible.

In existing systems, low latency communication is often achieved with by employing a poll strategy for communications. Instead of using a signalling service to wake up a process, a polling strategy continuously checks for input in a tight loop. This technique is applied in networking systems by using polling sockets. Linux has provided an application programming interface (NAPI), which uses polling to lower the overhead of interrupts. However, the NAPI is designed with throughput oriented considerations. Certain user space networking frameworks also use polling directly on a network interface card to achieve high throughput and low latency. Besides networking, polling is also applied in storage input/output (I/O) handling. The latency of remote procedure calls (RPCs) is also critical in existing systems. In some of these systems, polling and kernel bypass is used to achieve remote data access in a couple of microseconds.

Aside from performance requirements, energy efficiency is also a key factor in the design of large scale infrastructure, and will be an inherent part of 5G systems. However, continuously using polling in applications is not energy efficient and does not scale well as each polling thread utilises a full central processing unit (CPU) core even if there is no incoming data to process. This is especially problematic in the cloud where the same physical machines are shared among multiple virtual machines that interfere with each other. While polling is often preferred for performance orientated systems, most other system use an interrupt to notify when an input is received. For example, in some existing system, there is an application programming interface (API) option to disable polling and request a regular interrupt upon packet arrival. Thus, by applying a mixed handling strategy, it is possible to save a significant amount of energy. However, this is not a viable option for latency-sensitive functions, since interrupt handling is orders of magnitude slower than polling.

In some existing system, a sleeping wait strategy is used to lower energy consumption. However, this introduces a fixed delay (granularity) in servicing incoming data. Also, polling may still run hundreds or thousands of times until data arrives. A yielding wait strategy targets scalability as other processes can run. However, the central processing unit is still utilised 100% all of the time. Interrupt coalescing can be used to optimise the throughput of systems as the handling of hard interrupts seriously impacts the performance. This process involves collecting packet batches before raising the interrupt, which can significantly improve the throughput in a system. However, batch processing involves delaying packets and, as a result, directly and negatively impacts the latency of individual packets.

There is thus a need for an improved means for handling communications between nodes of a system.

### SUMMARY

It is an object to obviate or eliminate at least some of the above disadvantages and provide an improved means for handling communications between nodes of a system.

Therefore, according to an aspect of the idea, there is provided a method for handling communications between nodes of a system. The method comprises acquiring information indicative of at least one condition in the system and, for each request transmitted by a node of the system and targeted for another node of the system, selecting, based on the acquired information, a mode in which to wait for reception of a response to the request from the targeted node.

The idea thus provides an improved means for handling communications between nodes of a system. The most preferable or appropriate wait mode is selected for each individual request through the use of information on one or more conditions in the system. Thus, the most appropriate wait strategy is selected for each and every request individually. The idea can advantageously employ a mixed use of wait modes to achieve low latency and low energy consumption. In this way, an optimal balance between latency and energy consumption can be maintained in the system. It is possible to achieve low latency and energy efficiency in an optimal combination, on a per-request granularity. For example, there can be a good trade-off provided between latency and energy consumption for intra-data center (DC) data communications and the process can fall back to a more trivial solution in inter-DC data communications. The process by which the wait mode is selected is self-adapting and thus no globally pre-set modes are needed. The idea is also suitable for a cloud deployment, for example, as a platform as a service (PaaS).

In some embodiments, the mode in which to wait for reception of the response to the request from the targeted node may be adaptively selected based on the acquired information. This advantageously eliminates the need to manually configure the system during run-time, reducing the burden and overhead needed to configure the system. It is thus possible to dynamically adapt the wait mode on a per request level, potentially based on multiple inputs, rather than the mode to use being specifically defined.

In some embodiments, the information indicative of at least one condition in the system may be periodically acquired. This can advantageously account for changes in conditions in the system to ensure that the most appropriate mode in which to wait for reception of a response to a request from a targeted node is always selected.

In some embodiments, the method may comprise initiating a notification indicating the selected mode to the node of the system that transmitted the request. In this way, the node of the system that transmitted the request knows the correct wait mode to use and can thus implement such a wait mode.

In some embodiments, the method may comprise initiating a pairing of the request transmitted from the node of the system with the response to the request transmitted from the targeted node, for transmission of the response to the request. In this way, it is possible to identify which node transmitted the request such that it can be ensured that the correct node receives the response to the request.

In some embodiments, the information indicative of at least one condition in the system may comprise any one or more of: signalling service information indicative of an overhead of an execution time for an inter-process communication signalling service of the system (where the inter-process communication signalling service is for use in notifying the node of the system that transmitted the request when the response to the request is received from the targeted node), latency information indicative of an expected response time for reception of the response from the targeted node, and sleep information indicative of an accuracy of a sleep functionality of a requesting process of the node that transmitted the request and/or a minimum sleep time of the requesting process of the node that transmitted the request. Thus, relevant information can be acquired on the conditions in the system to more reliably select the best wait mode for each request, which will achieve the most optimum energy efficiency and latency for the system.

In some embodiments, the signalling service information may be based on a difference between response times previously experienced in a poll mode for reception of a response from the targeted node and response times previously experienced in a signalling service mode for reception of a response from the targeted node, wherein the poll mode continuously checks for receipt of a response to a request from the targeted node and the signalling service mode initiates a signalling service to notify when a response to a request is received from the targeted node. In this way, signalling service information can be acquired using real data flow, rather than through an artificial process, such that any changes to the conditions for the system are accounted for and the information acquired is as accurate as possible. This ensures that the optimal wait mode is selected. Moreover, by acquiring the signalling service information using real data flow, it is not necessary to inject additional traffic into the system in order to acquire the signalling service information, which limits the amount of traffic in the system and improves its operation.

In some embodiments, the latency information may be based on one or more response times previously experienced for reception of a response from the targeted node. In this way, latency information can be acquired using real data flow, rather than through an artificial process, such that any changes to the conditions for the system are accounted for and the information acquired is as accurate as possible. This ensures that the optimal wait mode is selected. Moreover, by acquiring the latency information using real data flow, it is not necessary to inject additional traffic into the system in order to acquire the latency information, which limits the amount of traffic in the system and improves its operation.

In some embodiments, the accuracy of the sleep functionality of the requesting process of the node that transmitted the request may be based on a comparison of an expected sleep time of the requesting process of the node that transmitted the request and an actual sleep time of the requesting process of the node that transmitted the request. In this way, the accuracy of the sleep functionality of the requesting process can be determined using real data flow, rather than through an artificial process, such that any changes to the conditions for the system are accounted for and the accuracy of the determined sleep functionality is as accurate as possible. This ensures that the optimal wait mode is selected. Moreover, by acquiring the accuracy of the sleep functionality using real data flow, it is not necessary to inject additional traffic into the system in order to acquire the accuracy of the sleep functionality, which limits the amount of traffic in the system and improves its operation.

In some embodiments, the mode may be selected from a signalling service mode which initiates a signalling service to notify when the response to the request is received from the targeted node, a poll mode which continuously checks for receipt of the response to the request from the targeted node, and a combined sleep and poll mode which waits an expected time for the reception of the response from the targeted node and initiates the poll mode at the expected time. In this way, a mix of different wait modes can be selected, thereby advantageously providing more options for achieving low latency and low energy consumption.

In some embodiments, if the overhead of the execution time for the inter-process communication signalling service of the system compared to the expected response time for reception of the response from the targeted node is less than a threshold time, the signalling service mode may be selected. In this way, the poll mode is fully elided to ensure energy efficient execution.

In some embodiments, if the expected response time for reception of the response from the targeted node is less than the minimum sleep time of the requesting process of the node that transmitted the request, the poll mode may be selected. This advantageously ensures the lowest possible latency (or the fastest response time).

In some embodiments, if the overhead of the execution time for the inter-process communication signalling service of the system compared to the expected response time for reception of the response from the targeted node is more than a threshold time and/or if the accuracy of the sleep functionality of the requesting process of the node that transmitted the request enables the combined sleep and poll mode, the combined sleep and poll mode may be selected. The mix of a sleep mode and a poll mode advantageously saves energy, without compromising on low latency requirements. The combined sleep and poll mode can be used for a vast amount of in communications, yielding energy saving without impacting on the latency.

According to another aspect of the idea, there is provided a computer program product, comprising a carrier containing instructions for causing a processor to perform a method as defined above. In some embodiments, the carrier is any one of an electronic signal, an optical signal, an electromagnetic signal, an electrical signal, a radio signal, a microwave signal, or a computer-readable storage medium.

According to another aspect of the idea, there is provided a communication node for handling communications between nodes of a system. The communication node comprises an acquisition module configured to acquire information indicative of at least one condition in the system and a selection module configured to, for each request transmitted by a node of the system and targeted for another node of the system, select, based on the acquired information, a mode in which to wait for reception of a response to the request from the targeted node. The idea thus provides the advantages discussed above in respect of the method for handling communications between nodes of a system.

According to another aspect of the idea, there is provided a communication node for handling communications between nodes of a system. The communication node comprises a communication module operable to acquire information indicative of at least one condition in the system and, for each request transmitted by a node of the system and targeted for another node of the system, select, based on the acquired information, a mode in which to wait for reception of a response to the request from the targeted node. The idea thus provides the advantages discussed above in respect of the method for handling communications between nodes of a system.

In some embodiments, the communication node may be a physical communication node or a virtual communication node. In this way, the communication node can be deployed in a variety of different environments and thus has a wider application.

In some embodiments, the communication module may be operable to acquire the information indicative of at least one condition in the system from at least one measurement module. In this way, by having modules that are specifically configured to acquire measurement information, it is easier to implement and/or change those modules. It is also possible to easily extend the system with additional modules.

In some embodiments, the communication node may comprise one or more of the at least one measurement modules. In this way, by having the measurement modules reside in the same node as the communication module, the measurement modules are able to acquire the information indicative of at least one condition in the system applying for the communication node to provide more relevant information and to thus achieve the optimal selection of wait mode.

In some embodiments, the one or more measurement modules may be operable to acquire any one or more of: signalling service information indicative of an overhead of an execution time for an inter-process communication signalling service of the system (where the inter-process communication signalling service for use in notifying the node of the system that transmitted the request when the response to the request is received from the targeted node), latency information indicative of an expected response time for reception of the response from the targeted node, and sleep information indicative of an accuracy of a sleep functionality of a requesting process of the node that transmitted the request and/or a minimum sleep time of the requesting process of the node that transmitted the request. In this way, relevant information can be acquired on the conditions in the system to more reliably select the best wait mode for each request, which will achieve the most optimum energy efficiency and latency for the system.

According to another aspect of the invention, there is provided a system. The system comprises at least one communication node, wherein one or more of the at least one communication nodes is as defined above. According to this aspect, there is provided a system in which the handling of communications between nodes of a system is improved in the manner described earlier.

In some embodiments, the system may comprise at least one node operable to transmit a request to a targeted node. In some embodiments, the system may comprise at least one targeted node operable to transmit a response to a request from at least one node. In some embodiments, the system may comprise at least one measurement module from which the information indicative of at least one condition in the system is acquired.

Therefore, an improved means for handling communications between nodes of a system is advantageously provided.

### BRIEF DESCRIPTION OF THE DRAWINGS

For a better understanding of the present idea, and to show how it may be put into effect, reference will now be made, by way of example, to the accompanying drawings, in which:

FIG. 1 is a block diagram illustrating a communication node in a system in accordance with an embodiment;

FIG. 2 is a block diagram illustrating a communication node in a system in a virtual environment in accordance with another embodiment;

FIG. 3 is a block diagram illustrating a method in accordance with an embodiment;

FIG. 4 is a block diagram illustrating a method in accordance with an example embodiment;

FIG. 5 is a block diagram illustrating a system in use in accordance with an embodiment;

FIG. 6 is a graphical illustration of the results of different modes in accordance with an embodiment; and

FIG. 7 is a block diagram illustrating a communication node in accordance with an embodiment.

### DETAILED DESCRIPTION

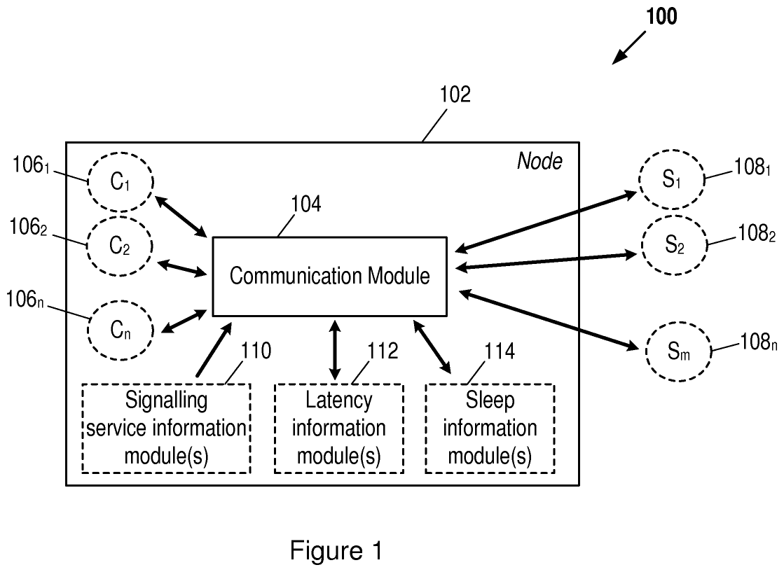

FIG. 1 illustrates a communication node 102 in a system 100 in accordance with an embodiment. The system 100 can, for example, be an operating system (OS). The communication node 102 is for use in handling communications between nodes 106₁, 106₂, 106ₙ, 108₁, 108₂, 108ₙ of the system 100. More specifically, the communication node 102 of the system 100 is operable to handle requests transmitted from at least one node 106₁, 106₂, 106ₙ and targeted for at least one other node 108₁, 108₂, 108ₙ. The system 100 may comprise any integer number n of nodes 106 that transmit requests. Similarly, the communication node 102 of the system 100 is operable to handle responses to the requests, where the responses are received from at least one targeted node 108₁, 108₂, 108ₙ. The system 100 may comprise any integer number n of targeted nodes 108. The communication module 102 can be the central component of the system 100. In effect, the communication module 102 acts as a proxy and handles the request-response communication of at least one node 106₁, 106₂, 106ₙ toward at least one targeted node 108₁, 108₂, 108ₙ.

The system 100 can thus comprise at least one node 106₁, 106₂, 106ₙ operable to transmit a request to a targeted node 108₁, 108₂, 108ₙ. In the illustrated embodiment of FIG. 1, the communication node 102 comprises the at least one node 106₁, 106₂, 106ₙ operable to transmit a request. However, in other embodiments, one or more, or all, of the at least one nodes 106₁, 106₂, 106ₙ operable to transmit a request may instead be external to (i.e. separate to or remote from) the communication node 102. The at least one node 106₁, 106₂, 106ₙ operable to transmit a request can, for example, be at least one client node, such as at least one client (c₁ . . . cₙ). Similarly, the system 100 can comprise at least one targeted node 108₁, 108₂, 108ₙ operable to transmit a response to a request from at least one node 106₁, 106₂, 106ₙ. In the illustrated embodiment of FIG. 1, the at least one targeted node 108₁, 108₂, 108ₙ is external to (i.e. separate to or remote from) the communication node 102 in the system 100. However, in other embodiments, the communication node 100 may instead comprise one or more, or all, of the at least one targeted nodes 108₁, 108₂, 108ₙ. The at least one targeted node 108₁, 108₂, 108ₙ can, for example, be at least one service node such as, at least one service, service instance, or server (s₁ . . . sₘ).

The system 100 can comprise at least one communication node 102 that is operable to handle communications between nodes 106₁, 106₂, 106ₙ, 108₁, 108₂, 108ₙ of the system 100 in the manner described herein. As illustrated in FIG. 1, the communication node 102 of the system 100 comprises a communication module 104. The communication module 104 controls the operation of the communication node 102 and can implement the method described herein. The communication module 104 can comprise one or more processors, processing units, multi-core processors or modules that are configured or programmed to control the communication node 102 in the manner described herein. In particular implementations, the communication module 104 can comprise a plurality of software and/or hardware modules that are each configured to perform, or are for performing, individual or multiple steps of the method disclosed herein.

Briefly, the communication module 104 is operable to acquire information indicative of at least one condition in the system 100 and, for each request transmitted by a node 106₁, 106₂, 106ₙ of the system 100 and targeted for another node 108₁, 108₂, 108ₙ of the system 100, select, based on the acquired information, a mode in which to wait for reception of a response to the request from the targeted node 108₁, 108₂, 108ₙ.

In some embodiments, the communication module 104 may itself be operable to acquire the information indicative of at least one condition in the system 100. Alternatively or in addition, in some embodiments, the communication module 104 can be operable to acquire the information indicative of at least one condition in the system 100 from at least one measurement module 110, 112, 114. The system 100 can thus comprise at least one measurement module 110, 112, 114 from which the information indicative of at least one condition in the system 100 is acquired. As illustrated in FIG. 1, the communication node 102 itself may comprise one or more of the at least one measurement module 110, 112, 114. Alternatively or in addition, one or more of the at least one measurement modules 110, 112, 114 can be external to (i.e. separate to or remote from) the communication node 102. In some embodiments, the same node (for example, the same communication node 102) can comprise all of the measurement modules 110, 112, 114 such that all information can be acquired on the same node. In an example embodiment, the communication module 104 and, optionally, the at least one measurement module 110, 112, 114 can be part of a single client application (for example, as a software library). The at least one measurement module 110, 112, 114 may comprise any one or more of a signalling service information module 110, a latency information module 112, a sleep information module 114, or any other measurement module, or any combination of modules, suitable for acquiring information indicative of at least one condition in the system 100.

In some embodiments, one or more of the at least one measurement modules 110 (for example, one or more signalling service information modules 110) may be operable to acquire signalling service information indicative of an overhead of an execution time for an inter-process communication signalling service of the system 100. The inter-process communication signalling service is for use in notifying the node 106₁, 106₂, 106ₙ of the system 100 that transmitted the request when the response to the request is received from the targeted node 108₁, 108₂, 108ₙ. Alternatively or in addition, one or more of the at least one measurement modules (for example, one or more latency information modules 112) may be operable to acquire latency information indicative of an expected response time for reception (or latency) of the response from the targeted node 108₁, 108₂, 108ₙ. Alternatively or in addition, one or more of the at least one measurement modules (for example, one or more sleep information modules 114) may be operable to acquire sleep information indicative of an accuracy of a sleep functionality of a requesting process of the node 106₁, 106₂, 106ₙ that transmitted the request, a minimum sleep time of the requesting process of the node 106₁, 106₂, 106ₙ that transmitted the request, or indicative of both the accuracy of the sleep functionality and the minimum sleep time. The various types of information that may be acquired will be explained in more detail later.

The communication node 102 of the system 100 can be a physical communication node (such as a physical computer) or a virtual communication node (such as a virtual machine). A virtual communication node 102 is a communication node 102 operating in a virtual environment, such as the cloud or the cloud platform.

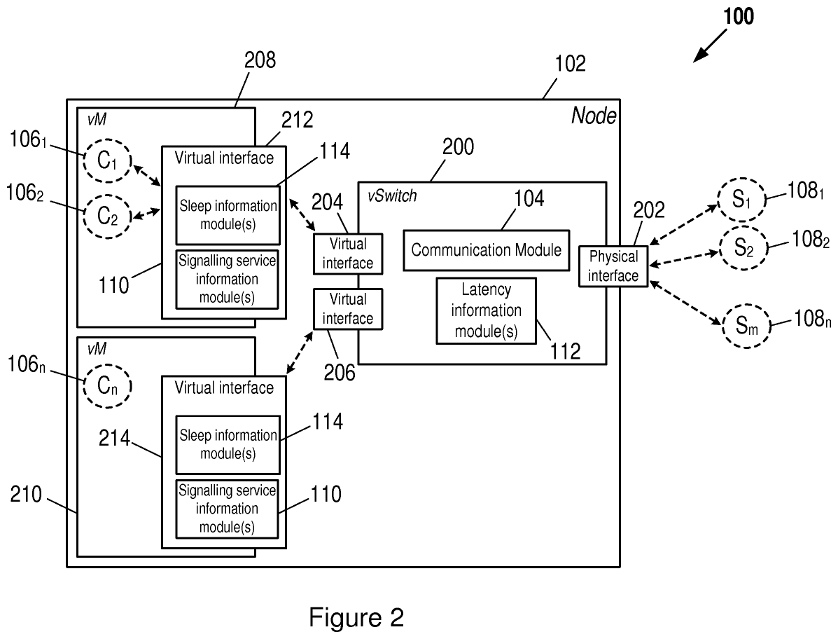

FIG. 2 is a block diagram illustrating the communication node 102 in the system 100 in a virtual environment for handling communications between nodes 106₁, 106₂, 106ₙ, 108₁, 108₂, 108ₙ of the system 100 in accordance with another embodiment.

In the illustrated embodiment of FIG. 2, the communication node 102 of the system comprises a virtual switch 200. The virtual switch 200 of the communication node 102 comprises the communications module 104. The virtual switch 200 can also comprise one or more physical interfaces 202 and one or more virtual interfaces 204, 206. The communication node 102 and the communications module 104 of the communication node 102 are operable in the manner described above with reference to FIG. 1, which will not be repeated here but will be understood to apply.

In the illustrated embodiment of FIG. 2, the communication node 102 of the system 100 comprises the at least one node 106₁, 106₂, 106ₙ (such as at least one client node) operable to transmit a request. However, in other embodiments, one or more, or all, of the at least one nodes 106₁, 106₂, 106ₙ operable to transmit a request may instead be external to (i.e. separate to or remote from) the communication node 102 in the system 100. The communication node 102 of the system 100 comprises one or more virtual nodes (for example, virtual machines) 208, 210. In effect, the communication node 102 of the system 100 acts as a physical host for the one or more virtual nodes 208, 210 (and also for the virtual switch 200 and any virtual interfaces 204, 206, 212, 214). The one or more virtual nodes 208, 210 can each comprise one or more of the at least one nodes 106₁, 106₂, 106ₙ operable to transmit a request. In this illustrated embodiment, the communication node 102 comprises a first virtual node 208 that comprises one or more of the at least one nodes 106₁, 1062 operable to transmit a request and a second virtual node 210 that comprises one or more of the at least one nodes 106ₙ operable to transmit a request. However, it will be understood that other configurations are also possible. The one or more virtual nodes 208, 210 can each comprise a virtual interface 212, 214. A virtual interface 212, 214 of a virtual node 208, 210 is in communication with one or more of the virtual interfaces 204, 206 of the virtual switch 200 of the communication node 102.

The system 100 can comprise at least one targeted node 108₁, 108₂, 108ₙ (such as at least one service or server node) operable to transmit a response to a request from at least one node 106₁, 106₂, 106ₙ. In the illustrated embodiment of FIG. 2, the at least one targeted node 108₁, 108₂, 108ₙ is external to (i.e. separate to or remote from) the communication node 102 in the system 100. However, in other embodiments, the communication node 100 may instead comprise one or more, or all, of the at least one targeted nodes 108₁, 108₂, 108ₙ. The at least one targeted node 108₁, 108₂, 108ₙ is in communication with the communication node 102 via at least one physical interface 202 of the virtual switch 200 of the communication node 102.

The system 100 can comprise at least one measurement module 110, 112, 114 from which the information indicative of at least one condition in the system 100 is acquired. In the illustrated embodiment of FIG. 2, the virtual interfaces 212, 214 of the virtual nodes 208, 210 of the communication node 102 comprise at least one signalling service information module 110 and at least one sleep information module 114. The at least one signalling service information module 110 and the at least one sleep information module 114 are included in the virtual node 212, 214 of the communication node 100 since the information acquired by these modules can vary between virtual nodes 208, 210, for example, based on operating system (OS) and kernel versions and the settings of the system 100. The virtual switch 200 of the communication node 102 comprises at least one latency information module 112.

The measurement modules 110, 112, 114 are operable in the manner described above with reference to FIG. 1, which will not be repeated here but will be understood to apply. In a configuration such as that illustrated in FIG. 2, the communication module 104 and the at least one measurement module 110, 112, 114 are provided in a plurality of different virtual components (including a virtual switch 200 and virtual nodes 208, 210), which means that the optimisation machinery in each virtual component is less and this can reduce the execution time overhead in the system.

Where the communication node 102 is operating in a virtual environment (such as the cloud or the cloud platform) and the method described herein is employed, energy consumption of a whole data center can be influenced while service level agreements (SLAs) can be kept intact. The method described herein can be implemented with all of the described modules in virtual nodes (for example, virtual machines or containers). However, an improved and more scalable approach can be provided by implementing the method described herein as part of a cloud platform. The method implemented as part of a cloud platform can, for example, be provided as a service for tenant applications. By implementing the method as part of a cloud platform, latency information does not have to be acquired for each virtual node on the same physical host (i.e. on the same communication node 102). Also, the signalling service information can be shared. The at least one sleep information module 114 may still be executed in each virtual node 206, 214 as scheduling conditions can vary.

Although example configurations for the system 100 have been illustrated in and described with reference to FIGS. 1 and 2, it will be understood that other configurations are also possible. For example, in an alternative embodiment of the system 100 in a virtual environment, a single virtual node may comprise the communication module 104 and each of the at least one measurement modules 110, 112, 114. This provides a simpler configuration for the system 100.

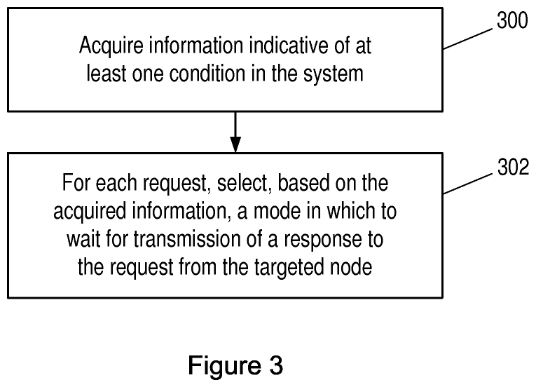

FIG. 3 is a block diagram illustrating a method for handling communications between the nodes 106₁, 106₂, 106ₙ, 108₁, 108₂, 108ₙ of a system 100 in accordance with an embodiment. The method can generally be performed by or under the control of the communication module 104 of the communication node 102.

With reference to FIG. 3, at block 300, information indicative of at least one condition in the system 100 is acquired. In some embodiments, the information indicative of at least one condition in the system 100 is periodically acquired. As previously mentioned, the information indicative of at least one condition in the system 100 can comprise any one or more of signalling service information (for example, acquired from one or more signalling service information modules 110), latency information (for example, acquired from one or more latency information modules 112), and sleep information (for example, acquired from one or more sleep information modules 114).

The signalling service information is indicative of an overhead of an execution time for an inter-process communication signalling service of the system 100, where the inter-process communication signalling service for use in notifying the node 106₁, 106₂, 106ₙ of the system 100 that transmitted the request when the response to the request is received from the targeted node 108₁, 108₂, 108ₙ. The inter-process communication signalling service of the system 100 can, for example, be a service that is operable to provide services for notifying processes when an input arrives.

In some embodiments, the signalling service information can be based on a difference between response times previously experienced by one or more signalling service information modules 110 in a poll mode for reception of a response from the targeted node 108₁, 108₂, 108ₙ and response times previously experienced by the one or more signalling service information modules 110 in a signalling service mode for reception of a response from the targeted node 108₁, 108₂, 108ₙ. Here, the poll mode continuously checks for receipt of a response to a request from the targeted node 108₁, 108₂, 108ₙ and the signalling service mode initiates a signalling service to notify when a response to a request is received from the targeted node 108₁, 108₂, 108ₙ. More details of the poll mode and signalling service mode will be provided later and will be understood to also apply here. The one or more signalling service information modules 110 may initiate dummy requests for the purpose of acquiring the signalling service information. The requests may be initiated through the communication module 104. The signalling service information acquired by the one or more signalling service information modules 110 can be made available to the communication module 104.

The latency information is indicative of an expected response time for reception (or the latency) of the response from the targeted node 108₁, 108₂, 108ₙ. In some embodiments, for example, the latency information can be based on one or more response times (or the latency) previously experienced for reception of a response from the targeted node 108₁, 108₂, 108ₙ. Thus, the at least one latency information module 112 may be configured to perform latency measurements towards one or more targeted nodes 108₁, 108₂, 108ₙ. For example, the at least one latency information module 112 may be configured to send requests towards one or more targeted nodes 108₁, 108₂, 108ₙ. The requests used can be dummy requests. Alternatively, actual requests (or a subset of actual requests) transmitted from one or more nodes 106₁, 106₂, 106ₙ can be used.

For each request sent toward a targeted node 108₁, 108₂, 108ₙ, the at least one latency information module 112 may be configured to save a time stamp (which may be a high precision time stamp) indicative of the time at which the request is sent. After receiving the response to the request, the at least one latency information module 112 may be configured to store a time stamp indicative of the time at which the response is received. The response time (or latency) toward the targeted node 108₁, 108₂, 108ₙ can then be determined as the time difference between the stored time stamps. Alternatively, the responses transmitted from the targeted nodes 108₁, 108₂, 108ₙ can be mapped to the nodes 106₁, 106₂, 106ₙ that transmitted the respective request, and the targeted nodes 108₁, 108₂, 108ₙ may be passively monitored to lower the overhead of the latency measurements. In order to determine the lowest possible latency (or the fastest response time), the requests may be issued in a poll mode. As the conditions of the system can change over time, latency information may be acquired periodically. The latency information acquired by the at least one latency information module 112 is made available to the communication module 104 of the communication node 102.

The sleep information is indicative of an accuracy of a sleep functionality of a requesting process of the node 106₁, 106₂, 106ₙ that transmitted the request, a minimum sleep time of the requesting process of the node 106₁, 106₂, 106ₙ that transmitted the request, or indicative of both the accuracy of the sleep functionality of the requesting process of the node 106₁, 106₂, 106ₙ and the minimum sleep time of the requesting process of the node 106₁, 106₂, 106ₙ. The minimum sleep time provides an indication of the granularity of the function of the underlying system 100. The accuracy of the sleep functionality of the requesting process of the node 106₁, 106₂, 106ₙ that transmitted the request can, in some embodiments, be based on a comparison of an expected sleep time of the requesting process of the node 106₁, 106₂, 106ₙ that transmitted the request and an actual sleep time of the requesting process of the node 106₁, 106₂, 106ₙ that transmitted the request. The accuracy of the sleep functionality of the requesting process of the node 106₁, 106₂, 106ₙ can, for example, depend on intrinsic characteristics or conditions of the execution environment (i.e. the system 100).

Even though a system 100 can offer sleep application programming interfaces (APIs) that operate on a nanosecond scale, the actual minimum sleep time is usually higher (for example, in the microsecond range) and can depend on certain aspects such as the scheduler algorithm used in the system, the system configuration, etc. When a system 100 is using sleep times having values above the minimum sleep time, the system 100 may still sleep longer than expected. Thus, it is useful to acquire sleep information is indicative of an accuracy of a sleep functionality of a requesting process of the node 106₁, 106₂, 106ₙ that transmitted the request.

In one example, this sleep information can be acquired by a process that is requesting a required sleep time (e.g. 100 microseconds) initiating sleep API calls to the system 100, which may be an operating system (OS). More specifically, the sleep information can be acquired by using an ascending set of sleep times and recording a time stamp (for example, a high precision time stamp) before and after each sleep API call. Then, the actual time spent in the sleep API calls can be determined, which can give an indication of an accuracy of the sleep functionality. For example, when measuring the accuracy of the sleep functionality, the at least one sleep information module 114 may record a time stamp of T1 before a sleep API call and a time stamp of T2 after the sleep API call. The actual time spent in the sleep API call (i.e. the actual sleep time) can then be determined as the difference between the time stamp T2 recorded after the call and the time stamp T1 recorded before the call (i.e. T2−T1). Then, when the requesting process of the node 106₁, 106₂, 106ₙ needs to use the sleep API call for sleeping the specified sleep time, the requesting process of the node 106₁, 106₂, 106ₙ can acquire the actual sleep time that is determined by the at least one sleep information module 114.

The at least one sleep information module 114 can thus provide a function that takes a required sleep time and determines the value that should be used in a sleep API call (i.e. the actual sleep time). In a virtual environment (such as a cloud environment) the accuracy of the sleep functionality may change over time, for example, as other virtual nodes are started and stopped on the same communication node 100. For this reason, the sleep information may be continually acquired to ensure the most up-to-date information is used in the selection of the wait mode and the most appropriate wait mode is selected. The at least one sleep information module 114 can publish the acquired sleep information (including the minimum sleep time and/or the accuracy of the sleep functionality) such that it is available to the communication module 104.

At block 302 of FIG. 3, for each request transmitted by a node 106₁, 106₂, 106ₙ of the system 100 and targeted for another node 108₁, 108₂, 108ₙ of the system 100, a mode (or strategy) in which to wait (or wait mode) for reception of a response to the request from the targeted node 108₁, 108₂, 108ₙ is selected based on the acquired information. The communication module 104 can, for example, select a wait mode for at least one client application. Thus, the most appropriate wait mode is selected by the communication module 104 for each and every request individually. In this way, the method described herein can apply the best mode individually for each request. In some embodiments, this can comprise examining to which targeted node 108₁, 108₂, 108ₙ the request is targeted.

The communication module 104 selects the wait strategy for a request using the information (or input) acquired from the one or more measurement modules 110, 112, 114. In some embodiments, the mode in which to wait for reception of the response to the request from the targeted node 108₁, 108₂, 108ₙ is adaptively selected based on the acquired information. In other words, the mode in which to wait for reception of the response to the request from the targeted node 108₁, 108₂, 108ₙ can be frequently updated such that is most accurately reflects the current conditions in the system 100. This can be useful since it eliminates the need to manually configure the system 100 during run-time, which can not only be cumbersome but can often require a large overhead. The mode in which to wait for reception of the response to the request from the targeted node 108₁, 108₂, 108ₙ can, for example, be selected from a signalling service mode, a poll mode, a combined sleep, poll mode, or any other suitable mode.

A signalling service mode is a mode which initiates a signalling service to notify (or signal) when the response to the request is received from the targeted node 108₁, 1082, 108n. For example, a signalling service mode may use an interrupt, a mutex, or similar, to notify when the response to the request is received from the targeted node 1081, 1082, 108n (or, in other words, when an input from the targeted node 1081, 1082, 108n arrives). An interrupt can be, for example, a hardware interrupt in a physical machine, an emulated interrupt in a virtual node, a software primitive interrupt (such as condition variables), or any other form of interrupt. In comparison to a poll mode, a signalling service mode is considered to be slow. However, a signalling service mode is more energy efficient compared to a poll mode since the signalling service mode does not execute instructions continuously.

A poll mode is a mode which continuously checks for receipt of the response to the request from the targeted node 108₁, 108₂, 108ₙ. For example, the checking can comprise checking for receipt of the response to the request from the targeted node 108₁, 108₂, 108ₙ (or checking for an input from the targeted node 108₁, 108₂, 108ₙ) in a tight loop. A combined sleep and poll mode is a mode which waits an expected time for the reception of the response from the targeted node 108₁, 108₂, 108ₙ and initiates the poll mode at the expected time (or the time for which to sleep before the reception of the response from the targeted node 108₁, 108₂, 108ₙ can be expected and the poll mode is initiated). For example, the process for checking for receipt of the response to the request from the targeted node 108₁, 108₂, 108ₙ may sleep until the response is expected to arrive and then the mode may be switched to the poll mode. The signalling service mode is the slowest of the modes but is the most energy efficient. The poll mode is the fastest of the modes but uses the most processing resource (for example, the poll mode can use a full central processing unit core) and is thus not energy efficient. The combined sleep and poll mode is both fast and energy efficient.

In some embodiments, if the expected response time for reception (or latency) of the response from the targeted node 108₁, 108₂, 108ₙ is less than the minimum sleep time of the requesting process of the node 106₁, 106₂, 106ₙ that transmitted the request, the poll mode is selected as the mode in which to wait for reception of a response to the request from the targeted node 108₁, 108₂, 108ₙ. In some embodiments, if the overhead of the execution time for the inter-process communication signalling service of the system 100 compared to the expected response time for reception (or latency) of the response from the targeted node 108₁, 108₂, 108ₙ is less than a threshold time, the signalling service mode is selected as the mode in which to wait for reception of a response to the request from the targeted node 108₁, 108₂, 108ₙ. For example, if the expected latency of a given request is large enough (such as between different data centers), the overhead of the signalling service becomes negligible, and a poll mode can be fully elided.

In some embodiments, if the overhead of the execution time for the inter-process communication signalling service of the system 100 compared to the expected response time for reception (or latency) of the response from the targeted node 108₁, 108₂, 108ₙ is more than a threshold time and/or if the accuracy of the sleep functionality of the requesting process of the node 106₁, 106₂, 106ₙ that transmitted the request enables the combined sleep and poll mode, the combined sleep and poll mode is selected as the mode in which to wait for reception of a response to the request from the targeted node 108₁, 108₂, 108ₙ.

In an example of selecting a mode in which to wait for reception of a response to the request from the targeted node 108₁, 108₂, 108ₙ for a communication node 102 operating in a virtual environment, one or more latency information modules 112 (as part of the virtual switch 200) may send requests periodically to the targeted node 108₁, 108₂, 108ₙ measuring the latency from the communication node 102, which is the current physical node. When a virtual interface 206, 214 of a virtual node (for example, a virtual machine) 212, 210 sends a request from a node 106₁, 106₂, 106ₙ to the virtual switch 200 via a virtual interface 204, 206 of the virtual switch 200, it also provides the minimum sleep time acquired from a sleep information module 114 and the overhead of the execution time for the inter-process communication signalling service of the system 100 acquired from a signalling service information module 110 (for example, as metadata). The virtual switch 200 then acquires from the latency information module 112 the expected response time for reception of a response to the request from the targeted node 108₁, 108₂, 108ₙ. The communication module 104 of the virtual switch then selects the most appropriate mode in which wait for reception of a response to the request from the targeted node 108₁, 108₂, 108ₙ, as described earlier, based on the information acquired by the virtual switch 200.

Once the appropriate mode in which to wait for reception of a response to the request from the targeted node 108₁, 108₂, 108ₙ (or wait mode) has been selected according to any of the embodiments disclosed herein, the communication module 104 implements the selected mode in respect of the request in which the mode is selected. Although not illustrated in FIG. 3, according to any of the embodiments described herein, the method may further comprise initiating a notification indicating the selected mode to the node 106₁, 106₂, 106ₙ of the system 100 that transmitted the request. In a virtual environment, the notification may be initiated from the communication module 104 of the virtual switch 200 via a virtual interface 204, 206 of the virtual switch 200 and a virtual interface 212, 214 of the virtual node 208, 210 on which the node 106₁, 106₂, 106ₙ of the system 100 that transmitted the request is operating. In this way, the decision on the appropriate wait mode is propagated back to the node 106₁, 106₂, 106ₙ of the system 100 that transmitted the request for which the wait mode is selected.

Although not illustrated in FIG. 3, according to any of the embodiments described herein, the method may further comprise initiating a pairing of the request transmitted from the node 106₁, 106₂, 106ₙ of the system 100 with the response to the request transmitted from the targeted node 108₁, 108₂, 108ₙ, for transmission of the response to the request. In this way, the communication module 104 can pair individual requests to responses and provide the responses to the nodes 106₁, 106₂, 106ₙ of the system 100 that transmitted the requests.

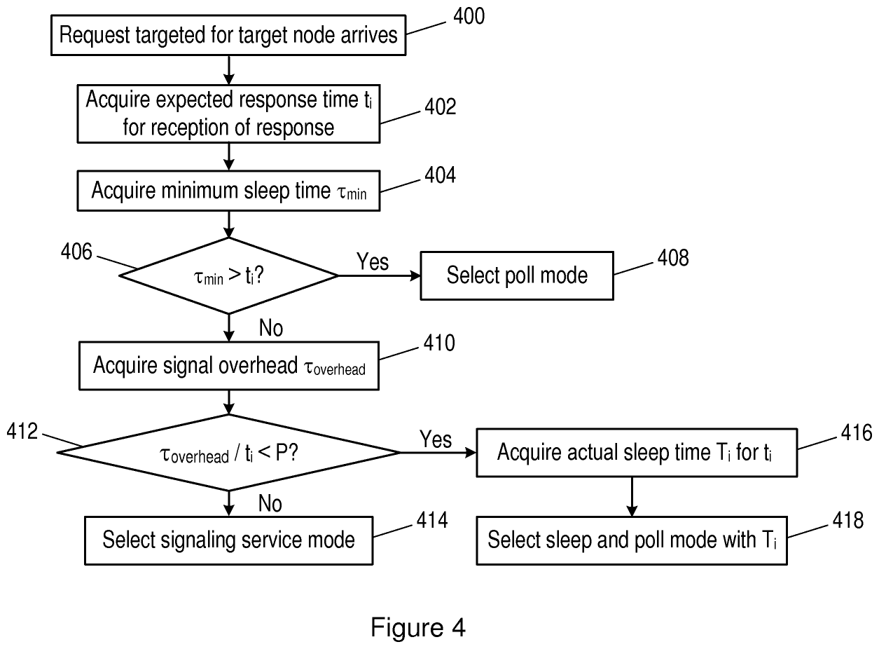

FIG. 4 is a block diagram illustrating a method for handling communications between the nodes 106₁, 106₂, 106ₙ, 108₁, 108₂, 108ₙ of a system 100 in accordance with an example embodiment.

With reference to FIG. 4, at block 400, a request transmitted by a node 106₁, 106₂, 106ₙ of the system 100 and targeted for at least one targeted node 108₁, 108₂, 108ₙ of the system 100 arrives at the communication node 102 of the system 100. At block 402 of FIG. 4, the communication module 104 of the communication node 102 acquires latency information, for example, from at least one latency information module 112 of the system 100. As described earlier, the acquired latency information is indicative of an expected response time tᵢ for reception of a response to the request from the targeted node 108₁, 108₂, 108ₙ.

At block 404 of FIG. 4, the communication module 104 of the communication node 102 acquires sleep information, for example, from at least one sleep information module 114 of the system 100. As described earlier, the acquired sleep information is indicative of a minimum sleep time τₘᵢₙ of the requesting process of the node 106₁, 106₂, 106ₙ that transmitted the request. At block 406 of FIG. 4, it is determined whether the minimum sleep time τₘᵢₙ of the requesting process of the node 106₁, 106₂, 106ₙ that transmitted the request is greater than the expected response time tᵢ for reception of the response to the request from the targeted node 108₁, 108₂, 108ₙ, (i.e. whether τₘᵢₙ>tᵢ). If the minimum sleep time τₘᵢₙ of the requesting process of the node 106₁, 106₂, 106ₙ that transmitted the request is greater than the expected response time tᵢ (or the latency) for reception of the response to the request from the targeted node 108₁, 108₂, 108ₙ, (i.e. if τₘᵢₙ>tᵢ), then the method proceeds to block 408 of FIG. 4 and the communication module 104 selects the poll mode as the mode in which to wait for reception of a response to the request from the targeted node 108₁, 108₂, 108ₙ. In other words, the communication module 104 selects a poll mode if the expected response time tᵢ (or the latency) for reception of the response to the request from the targeted node 108₁, 108₂, 108ₙ is lower than the minimum sleep time τₘᵢₙ. This ensures the lowest possible latency (or the fastest response time).

On the other hand, if the minimum sleep time τₘᵢₙ of the requesting process of the node 106₁, 106₂, 106ₙ that transmitted the request is less than or equal to the expected response time tᵢ for reception of the response to the request from the targeted node 108₁, 108₂, 108ₙ, (i.e. if τₘᵢₙ≤tᵢ), then the method proceeds to block 410 of FIG. 4 and the communication module 104 acquires signalling service information, for example, from at least one signalling service information module 110. As described earlier, the acquired signalling service information is indicative of an overhead of an execution time τ_{overhead} for an inter-process communication signalling service of the system 100, where the inter-process communication signalling service for use in notifying the node 106₁, 106₂, 106ₙ of the system 100 that transmitted the request when the response to the request is received from the targeted node 108₁, 108₂, 108ₙ.

Then, at block 412 of FIG. 4, it is determined whether the overhead of the execution time τ_{overhead} for the inter-process communication signalling service of the system 100 compared to the expected response time tᵢ for reception of the response from the targeted node 108₁, 108₂, 108ₙ (or the ratio of the overhead of the execution time τ_{overhead} to the expected response time tᵢ) is less than a threshold time P (i.e. whether τ_{overhead}/tᵢ<P). The overhead of the execution time τ_{overhead} can be used to judge whether it is reasonable to apply the sleep and poll mode. The threshold time P is used to decide if the overhead of the execution time τ_{overhead} is negligible. The threshold time P can be set in a variety of ways. For example, the threshold time may be set to a specific number (for example, 0.05 or any other number) or the threshold time P may be set for a given configuration. In some embodiments, the threshold time P may be exposed to the nodes 106₁, 106₂, 106ₙ from which requests are transmitted, which can allow finer control over sleep times for each request. In some embodiments, such as embodiments where the measurement modules 110, 112, 114 provide acquired information in the form of distributions, the execution time τ_{overhead} and the expected response time tᵢ may be compared statistically.

If the overhead of the execution time τ_{overhead} for the inter-process communication signalling service of the system 100 compared to the expected response time tᵢ for reception of the response from the targeted node 108₁, 108₂, 108ₙ (or the ratio of the overhead of the execution time τ_{overhead} to the expected response time tᵢ) is greater than or equal to the threshold time P (i.e. if τ_{overhead}/tᵢ≥P), then the method proceeds to block 414 of FIG. 4 and the communication module 104 of the communication node 102 selects the signalling service mode as the mode in which to wait for reception of a response to the request from the targeted node 108₁, 108₂, 108ₙ.

On the other hand, if the overhead of the execution time τ_{overhead} for the inter-process communication signalling service of the system 100 compared to the expected response time tᵢ for reception of the response from the targeted node 108₁, 108₂, 108ₙ (or the ratio of the overhead of the execution time τ_{overhead} to the expected response time tᵢ) is less than the threshold time P (i.e. if τ_{overhead}/tᵢ<P), then the method proceeds to block 416 and the communication module 104 of the communication node 102 acquires further sleep information, for example, from at least one sleep information module 114. This can comprise the communication module 104 acquiring an actual sleep time Tᵢ for the expected response time tᵢ from at least one sleep information module 114. The actual sleep time Tᵢ can, for example, be determined in the manner described earlier. In a virtual environment, the actual sleep time may be determined on the virtual node side of the communication node 102 using a sleep information module 114.

Then, at block 418 of FIG. 4, the communication module 104 of the communication node 102 selects the combined sleep and poll mode as the mode in which to wait for reception of a response to the request from the targeted node 108₁, 108₂, 108ₙ. The combined sleep and poll mode uses the actual sleep time Tᵢ as the expected time to wait for the reception of the response from the targeted node 108₁, 108₂, 108ₙ (or the time for which to sleep before the reception of the response from the targeted node 108₁, 108₂, 108ₙ can be expected). The actual sleep time Tᵢ can be determined in the manner described earlier.

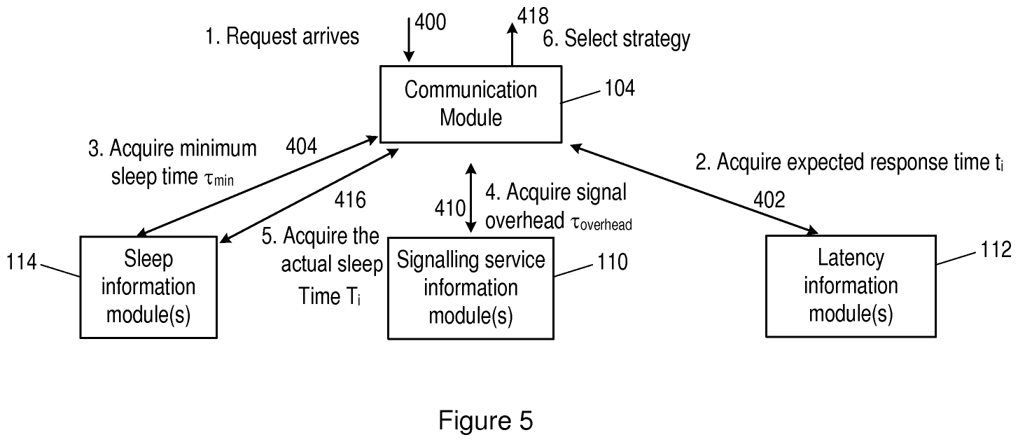

FIG. 5 is a block diagram illustrating a system in use in accordance with the example embodiment of FIG. 4. More specifically, FIG. 5 illustrates the interactions between the various modules during the decision process performed by way of the method of the example embodiment of FIG. 4.

Firstly, a request transmitted by a node 106 of the system 100 and targeted for at least one targeted node 108 of the system 100 arrives at the communication node 102 of the system 100 (block 400 of FIG. 4). Then, the communication module 104 acquires latency information from at least one latency information module 112 of the system 100, where the acquired latency information is indicative of an expected response time tᵢ for reception of a response to the request from the targeted node 108₁, 108₂, 108ₙ (block 402 of FIG. 4). Next, the communication module 104 acquires sleep information from at least one sleep information module 114 of the system 100, where the acquired sleep information is indicative of a minimum sleep time τₘᵢₙ of the requesting process of the node 106₁, 106₂, 106ₙ that transmitted the request (block 404 of FIG. 4).

In this illustrated example embodiment, the minimum sleep time τₘᵢₙ of the requesting process of the node 106₁, 106₂, 106ₙ that transmitted the request is determined to be less than (or equal) to the expected response time tᵢ for reception of the response to the request from the targeted node 108₁, 108₂, 108ₙ, (i.e. τₘᵢₙ≤tᵢ) and thus the communication module 104 proceeds to acquire signalling service information from at least one signalling service information module 110 (block 410 of FIG. 4). The acquired signalling service information is indicative of an overhead of an execution time τ_{overhead} for an inter-process communication signalling service of the system 100, where the inter-process communication signalling service for use in notifying the node 106₁, 106₂, 106ₙ of the system 100 that transmitted the request when the response to the request is received from the targeted node 108₁, 108₂, 108ₙ.

In this illustrated example embodiment, the overhead of the execution time τ_{overhead} for the inter-process communication signalling service of the system 100 compared to the expected response time tᵢ for reception of the response from the targeted node 108₁, 108₂, 108ₙ (or the ratio of the overhead of the execution time τ_{overhead} to the expected response time tᵢ) is determined to be less than the threshold time P (i.e. τ_{overhead}/tᵢ<P) and thus the communication module proceeds to acquire further sleep information from at least one sleep information module 114 (block 416 of FIG. 4). More specifically, the communication module 104 acquires an actual sleep time Tᵢ for the expected response time t′E from at least one sleep information module 114.

In this illustrated example embodiment, the communication module 104 of the communication node 102 selects the combined sleep and poll mode as the mode in which to wait for reception of a response to the request from the targeted node 108₁, 108₂, 108ₙ (block 418 of FIG. 4). However, it will be understood that this is only one example embodiment and in other example embodiments, different decisions may be taken by the communication module 104. Based on the outcome of the decisions of the communication module 104, certain steps may not be necessary for the strategy selection (for example, blocks 410, 412, 414, 416, and 418 of FIG. 4 are not necessary where a poll mode is selected and blocks 416 and 418 are not necessary where a signalling service mode is selected).

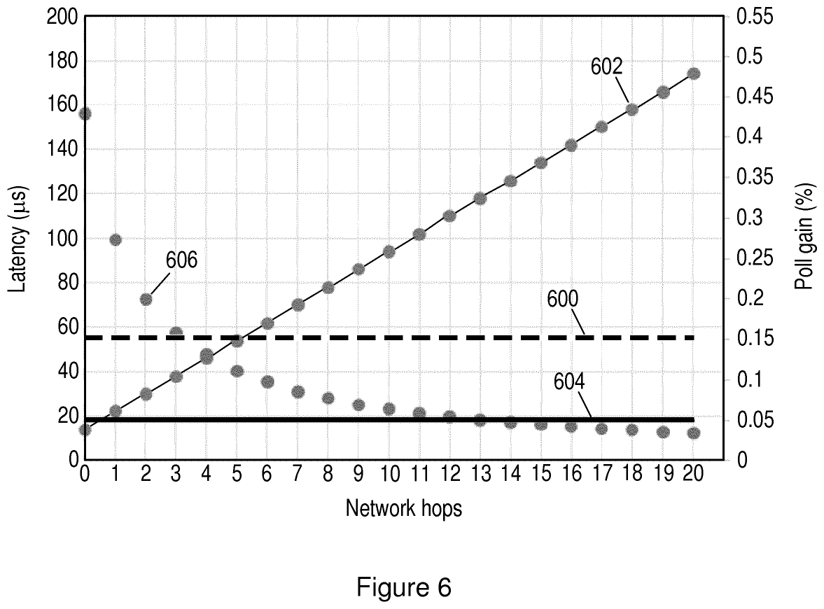

FIG. 6 is a graphical illustration of the results of different modes in accordance with an embodiment. The results were obtained using servers as the nodes in communication with each other, with Ubuntu 16.04 running on Intel Xeon E5-2670 v3 central processing units (CPUs) and equipped with Intel X540-AT2 network interface cards. A low-latency distributed in-memory database service was used.

The minimum sleep time τₘᵢₙ 600 was determined to be 55 μs and the actual sleep time Tᵢ for the expected response time tᵢ above this minimum sleep time τₘᵢₙ was approximately linear with 54-55 μs offset from the given expected response time tᵢ. However, it will be understood that this trend may be different based on, for example, the CPU, kernel, load, etc, and thus continuous acquisition of the information indicative of the at least one condition in the system can be beneficial. The data access between two directly connected servers with a poll mode in operation was 14 μs and the data access between two directly connected servers with the signalling service mode in operation was 20 μs. Therefore, the overhead of the execution time τ_{overhead} was measured to be 6 μs. This overhead is expected to increase with system load. By including a commodity switch between the two servers, the latency increased to 22 μs for the poll mode and 28 μs for the signalling service mode, and thus the latency of the switch was 8 μs.

FIG. 6 shows how the communication module 104 can coordinate the switching between the a poll mode, a signalling service mode and a combined sleep and poll mode based on the expected response time tᵢ 602 for the given targeted server of each and every request (or, in this example, operation). In this demonstrated example, the latency of multiple network hops were projected in a data center. As can be seen from FIG. 6, a poll mode is used under 5 network hops because the minimum sleep time τₘᵢₙ 600 is higher than the latency (or the expected response time tᵢ) 602. Above 5 network hops, it becomes possible to sleep before switching to a poll mode. Thus, the sleep information module 114 is used to acquire appropriate values for the sleep functionality, for example, Tᵢ(tᵢ=80)≈25. In this particular example, the threshold time P 604 was selected to be 0.05. As the delay increases, the gain of using a combined sleep and poll mode decreases and, above 14 network hops, the communication module switches to a signalling service strategy. This is the point at which the ratio of the overhead of the execution time τ_{overhead} to the expected response time tᵢ 606 is less than the threshold time P 604.

As shown in FIG. 6, in this particular example, a combined sleep and poll mode can be used between 5 and 14 network hops for a system having the configuration used for this example. Even in a medium-sized data center, a combined sleep and poll mode can be applied for nearly all of the non-rack and row-local communication. This is beneficial as a combined sleep and poll mode uses close to 0% CPU usage with having the same latency that a poll mode can achieve with 100% CPU usage, thereby resulting in significant energy savings.

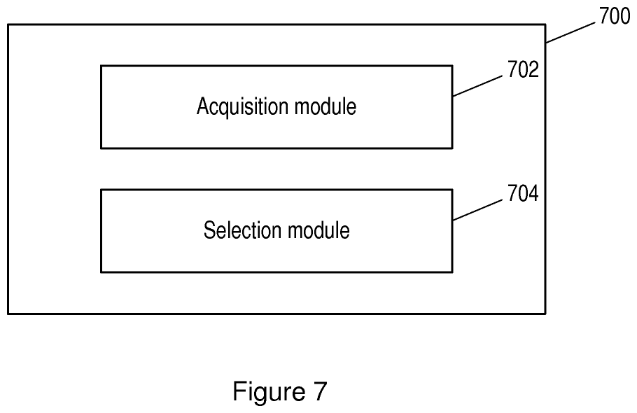

FIG. 7 is a block diagram illustrating a communication node 700 of a system 100 for handling communications between nodes 106₁, 106₂, 106ₙ, 108₁, 108₂, 108ₙ of the system 100 in accordance with an embodiment. With reference to FIG. 7, the communication node 700 of the system 100 comprises an acquisition module 702 configured to acquire information indicative of at least one condition in the system 100. The communication node 700 also comprises a selection module 704 configured to, for each request transmitted by a node 106₁, 106₂, 106ₙ of the system 100 and targeted for another node 108₁, 108₂, 108ₙ of the system 100, select, based on the acquired information, a mode in which to wait for reception of a response to the request from the targeted node 108₁, 108₂, 108ₙ.

In an example embodiment, the communication node and method described herein may be implemented in a platform as a service (PaaS) environment. For example, in a PaaS environment, a platform provides a collection of application programming interfaces (APIs) to an application, which used the collection of APIs to issue requests to various services (e.g. a data lookup). Whenever a request is issued over an API, a library providing the API may query the communication module 104 of the communication node 102 disclosed herein to select the best wait strategy and to wait for a response according to the selected strategy. This may be implemented without modifying the APIs. In other words, the query may be kept transparent to the application code. The communication node 102 and method provided herein may be implemented, for example, in large scale infrastructures, in industrial control systems, in connected vehicles, in user space networking frameworks, in storage input/output (I/O) handling in 5G applications (or in any other generation applications), or any other situations in which low latency, energy efficiency and high throughput is beneficial.

There is also provided a computer program product comprising a carrier containing instructions for causing at least one processor to perform at least part of the method described herein. In some embodiments, the carrier can be any one of an electronic signal, an optical signal, an electromagnetic signal, an electrical signal, a radio signal, a microwave signal, or a computer-readable storage medium.

There is thus advantageously provided herein a communication node in a system and a method for improved handling of communications between nodes of the system.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1 25. (canceled)

26. A method for handling communications between nodes of a system, the method comprising:
acquiring information indicative of at least one condition in the system; and
for each request transmitted by a requesting node of the system to a targeted node of the system, selecting, based on the acquired information, a mode in which to wait for reception of a response to the request from the targeted node.

27. The method of claim 26, wherein acquiring the information indicative of at least one condition in the system is performed periodically.

28. The method of claim 26, further comprising:
initiating a notification indicating the selected mode to the requesting node.

29. The method of claim 26, further comprising initiating a pairing of a request transmitted from the requesting node with a corresponding response transmitted from the targeted node.

30. The method of claim 26, wherein the information indicative of at least one condition in the system comprises one or more of the following:
signalling service information indicating an overhead of an execution time for an inter-process communication signalling service of the system, the inter-process communication signalling service for use in notifying a requesting node that transmitted a request when a response to a request is received from a targeted node;
latency information indicating an expected response time for reception of a response from a targeted node; and
sleep information indicating one or more of the following related to a requesting process of the requesting node:
an accuracy of a sleep functionality, and
a minimum sleep time.

31. The method of claim 30, wherein:
the signalling service information is based on a difference between:
response times previously experienced in a poll mode for reception of a response from the targeted node, and
response times previously experienced in a signalling service mode for reception of a response from the targeted node;
the poll mode includes continuously checking for reception of a response from the targeted node; and
the signalling service mode includes initiating a signalling service to notify when a response is received from the targeted node.

32. The method of claim 30, wherein the latency information is based on one or more response times previously experienced for reception of a response from the targeted node.

33. The method of claim 30, wherein the accuracy of the sleep functionality is based on a comparison of an expected sleep time an actual sleep time, of the requesting process of the requesting node.

34. The method of claim 26, wherein the mode is selected from:
a signalling service mode that includes initiating a signalling service to notify when the response is received from the targeted node;
a poll mode that includes continuously checking for reception of the response from the targeted node;
a combined sleep and poll mode that includes waiting an expected time for the reception of the response from the targeted node and initiating the poll mode at the expected time.

35. The method of claim 34, wherein the signalling service mode is selected if the overhead of the execution time for the inter-process communication signalling service of the system compared to the expected response time for reception of the response from the targeted node is less than a threshold time.

36. The method of claims 34, wherein the poll mode is selected if the expected response time for reception of the response from the targeted node is less than the minimum sleep time of the requesting process of the requesting node.

37. The method of claim 34, wherein the combined sleep and poll mode is selected based on any of the following conditions:
if the overhead of the execution time for the inter-process communication signalling service of the system compared to the expected response time for reception of the response from the targeted node is more than a threshold time; and
if the accuracy of the sleep functionality of the requesting process of the requesting node enables the combined sleep and poll mode.

38. A communication node for handling communications between requesting nodes and targeted nodes of a system, the communication node comprising:
a communication module comprising one or more processors that, by execution of instructions, configure the communication module to:
acquire information indicative of at least one condition in the system; and
for each request transmitted by a requesting node of the system to a targeted node of the system, select, based on the acquired information, a mode in which to wait for reception of a response to the request from the targeted node.

39. The communication node of claim 38, wherein:
execution of the instructions further configures the communication module to acquire the information indicative of at least one condition in the system from at least one measurement module; and
the communication node further comprises one or more of the at least one measurement modules.

40. The communication node of claim 39, wherein the one or more measurement modules are configured to acquire any of the following:
signalling service information indicating an overhead of an execution time for an inter-process communication signalling service of the system, the inter-process communication signalling service for use in notifying a requesting node that transmitted a request when a response to a request is received from a targeted node;
latency information indicating an expected response time for reception of a response from a targeted node; and
sleep information indicating one or more of the following related to a requesting process of the requesting node:
an accuracy of a sleep functionality, and
a minimum sleep time.

41. The communication node of claim 38, wherein the mode is selected from:
a signalling service mode that includes initiating a signalling service to notify when the response is received from the targeted node;
a poll mode that includes continuously checking for reception of the response from the targeted node;
a combined sleep and poll mode that includes waiting an expected time for the reception of the response from the targeted node and initiating the poll mode at the expected time.

42. The communication node of claim 41, wherein:
the signalling service mode is selected if the overhead of the execution time for the inter-process communication signalling service of the system compared to the expected response time for reception of the response from the targeted node is less than a threshold time; and
the poll mode is selected if the expected response time for reception of the response from the targeted node is less than the minimum sleep time of the requesting process of the requesting node.

43. A system comprising:
the communication node of claim 39;
at least one requesting node operable to transmit a request to a targeted node of the system; and
at least one targeted node operable to transmit a response to a request received from a requesting node of the system.

44. The system of claim 43, further comprising at least one measurement module from which the information indicative of at least one condition in the system is acquired.

45. A non-transitory, computer-readable medium storing computer-executable instructions that, when executed by one or more processors of a communication module, configure a communication node to perform operations corresponding to the method of claim 26.
